(19) United States
(12) Patent Application Publication
(10) Pub. No.: US 2022/0227348 A1
(43) Pub. Date: Jul. 21, 2022

(54) CONTROL APPARATUS FOR HYBRID ELECTRIC VEHICLE

(71) Applicant: TOYOTA JIDOSHA KABUSHIKI KAISHA, Toyota-shi (JP)

(72) Inventors: Hironobu ARATAKE, Chiryu-shi (JP); Yoshiaki TSURUTA, Nagakute-shi (JP); Yoshio HASEGAWA, Chiryu-shi (JP); Takahiko TSUTSUMI, Nisshin-shi (JP)

(73) Assignee: TOYOTA JIDOSHA KABUSHIKI KAISHA, Toyota-shi (JP)

(21) Appl. No.: 17/578,846

(22) Filed: Jan. 19, 2022

(30) Foreign Application Priority Data
Jan. 21, 2021 (JP) 2021-008335

(51) Int. Cl. B60W 10/119; B60W 20/30; B60K 6/52; B60W 10/06; B60W 10/08; B60W 30/18; B60K 6/387; B60W 10/02; B60W 10/11

(52) U.S. Cl. CPC B60W 10/119; B60W 2710/1005; B60K 6/52; B60W 10/06; B60W 10/08; B60W 30/18063; B60K 6/387; B60W 10/02; B60W 10/11; B60W 2710/06; B60W 2720/403; B60W 2540/10; B60W 2710/083; B60W 2710/02; B60W 2520/04; B60W 20/30

(57) ABSTRACT

A control apparatus for a hybrid electric vehicle includes: an engine control portion for controlling an operation state of an engine; and a driving-mode control portion for controlling the vehicle so as to realize selected driving mode or modes. The driving modes include a main-drive-wheel driving mode in which a drive power is distributed to main drive wheels, and an all-wheel driving mode in which the drive power is distributed to the main and auxiliary drive wheels. When the all-wheel driving mode is selected in the main-drive-wheel driving mode with the engine being in a stopped state, the engine control portion is configured to maintain the stopped state of the engine until completion of switching from the main-drive-wheel driving mode to the all-wheel driving mode, and to start the engine after a predetermined operation is executed by the driver of the vehicle to drive the vehicle.

This application claims priority from Japanese Patent Application No. 2021-008335 filed on Jan. 21, 2021, the disclosure of which is herein incorporated by reference in its entirety.

### FIELD OF THE INVENTION

The present invention relates to a control apparatus for a hybrid electric vehicle that includes an engine and an electric motor.

### BACKGROUND OF THE INVENTION

There is well-known a control apparatus or a drive apparatus for a hybrid electric vehicle that includes an engine, an electric motor, main and auxiliary drive wheels and a drive-power distribution device configured to distribute a drive power to the main and auxiliary drive wheels. A drive apparatus for a hybrid electric vehicle described in JP2016-179780A is an example of such a drive apparatus. This Japanese Patent Application Publication discloses driving modes including a first mode and a second mode, wherein a power performance is more important than an energy efficiency in the second mode as compared with in the first mode, and wherein the engine is started if the engine is in its stopped state when the second mode is selected by a driver of the vehicle. The Japanese Patent Application Publication further discloses a transfer low driving mode that belongs to the second mode. In the transfer low driving mode, the vehicle runs with a low gear position being established in a transmission provided in a transfer as the drive-power distribution device.

### SUMMARY OF THE INVENTION

By the way, there is also well-known a vehicle having a main-drive-wheel driving mode in which the vehicle is to run with the drive power being distributed to the main drive wheels, and an all-wheel driving mode in which the vehicle is to run with the drive power being distributed to the main drive wheels and the auxiliary drive wheels. In such a vehicle, the power performance is likely to be more important than the energy efficiency in the all-wheel driving mode as compared with in the main-drive-wheel driving mode. Therefore, when the main-drive-wheel driving mode is switched to the all-wheel driving mode with the engine being in its stopped state, it is conceivable to start the engine. However, when the vehicle driver selects the all-wheel driving mode so as to switch from the main-drive-wheel driving mode to the all-wheel driving mode, there is a possibility that the vehicle driver does not necessarily have an intention to start the engine. Therefore, if the engine is started immediately when the all-wheel driving mode is selected, there is a risk that a sense of discomfort could be given to the vehicle driver. Further, if the engine is started immediately when the all-wheel driving mode is selected, there is a possibility that switching to the all-wheel driving mode could be executed concurrently with starting of the engine, thereby causing a shock in the hybrid electric vehicle and accordingly causing a risk that the sense of discomfort could be given to the vehicle driver.

The present invention was made in view of the background art described above. It is therefore an object of the present invention to provide a control apparatus for a hybrid electric vehicle, which is capable of making the vehicle driver hardly feel uncomfortable when the all-wheel driving mode is selected.

The object indicated above is achieved according to the following aspects of the present invention.

According to a first aspect of the invention, there is provided a control apparatus for a hybrid electric vehicle that includes an engine, an electric motor, main and auxiliary drive wheels and a drive-power distribution device configured to distribute a drive power to the main and auxiliary drive wheels, the control apparatus comprising: an engine control portion configured to control an operation state of the engine; and a driving-mode control portion configured to control running of the vehicle so as to realize selected at least one of driving modes which is selected by a driver of the vehicle, wherein the driving modes include a main-drive-wheel driving mode in which the vehicle is to run with the drive power being distributed to the main drive wheels, and an all-wheel driving mode in which the vehicle is to run with the drive power being distributed to the main drive wheels and the auxiliary drive wheels, and wherein, when the all-wheel driving mode is selected in the main-drive-wheel driving mode with the engine being in a stopped state, the engine control portion is configured to maintain the stopped state of the engine until completion of switching from the main-drive-wheel driving mode to the all-wheel driving mode by the driving-mode control portion, and to start the engine after a predetermined operation is executed by the driver of the vehicle to cause the vehicle to run. It is noted that the driving-mode control portion may be defined also as a control portion configured to control a vehicle power transmission apparatus (that is described below) so as to realize selected at least one of driving modes which is selected by a driver of the vehicle or which is automatically selected.

According to a second aspect of the invention, in the control apparatus according to the first aspect of the invention, the all-wheel driving mode is a driving mode in which the operation state of the engine is controlled such that an engine operation ratio, which is a ratio of an operation time of the engine to an operation time of the vehicle, is higher in the all-wheel driving mode than in the main-drive-wheel driving mode.

According to a third aspect of the invention, in the control apparatus according to the first or second aspect of the invention, the predetermined operation is an acceleration requesting operation for increasing the drive power.

According to a fourth aspect of the invention, in the control apparatus according to the first or second aspect of the invention, the vehicle includes a vehicle power transmission apparatus including the drive-power distribution device and configured to transmit the drive power toward the main and auxiliary drive wheels, wherein the vehicle power transmission apparatus is to be selectively placed in a driving position that enables transmission of the drive power and a non-driving position that disables the transmission of the drive power, wherein the predetermined operation is an acceleration requesting operation for increasing the drive power, and wherein, in a case in which a switching operation is executed for switching from a state for selecting the non-driving position of the vehicle power transmission apparatus to a state for selecting the driving position of the vehicle power transmission apparatus, when the all-wheel driving mode is selected in the main-drive-wheel driving mode with the vehicle being stopped, the engine control portion is configured to maintain the stopped state of the engine, and to start the engine when the acceleration requesting operation is executed after execution of the switching operation.

According to a fifth aspect of the invention, in the control apparatus according to the first or second aspect of the invention, there is further provided an electric-motor control portion that is configured to cause the electric motor to output a predetermined torque causing a creep phenomenon in a case in which the engine is in the stopped state when the main-drive-wheel driving mode is switched to the all-wheel driving mode.

According to a sixth aspect of the invention, in the control apparatus according to the fifth aspect of the invention, in a case in which the main-drive-wheel driving mode is selected in the all-wheel driving mode when the predetermined torque is being outputted from the electric motor, the electric-motor control portion is configured to reduce an output torque of the electric motor form the predetermined torque toward zero after a predetermined time has elapsed from completion of switching from the all-wheel driving mode to the main-drive-wheel driving mode by the driving-mode control portion.

According to a seventh aspect of the invention, in the control apparatus according to the sixth aspect of the invention, the vehicle includes a vehicle power transmission apparatus including the drive-power distribution device and configured to transmit the drive power toward the main and auxiliary drive wheels, wherein the vehicle power transmission apparatus is to be selectively placed in a driving position that enables transmission of the drive power and a non-driving position that disables the transmission of the drive power, and wherein the electric-motor control portion is configured to reduce the output torque of the electric motor, in a case in which the all-wheel driving mode is switched to the main-drive-wheel driving mode when the vehicle power transmission apparatus is in the non-driving position.

According to an eighth aspect of the invention, in the control apparatus according to the first or second aspect of the invention, the drive-power distribution device includes a transmission in which a selected one of a low gear position and a high gear position is to be established by operation of a dog clutch, wherein the all-wheel driving mode is categorized into a low-gear all-wheel driving mode in which the low gear position is established in the transmission and a high-gear all-wheel driving mode in which the high gear position is established in the transmission, wherein the main-drive-wheel driving mode is a high-gear main-drive-wheel driving mode in which the high gear position is established in the transmission, and wherein the control apparatus further comprises an electric-motor control portion that is configured to cause the electric motor to output a predetermined torque causing a creep phenomenon, in a case in which the engine is in the stopped state when the high-gear main-drive-wheel driving mode is switched to the high-gear all-wheel driving mode during stop of the vehicle.

According to a ninth aspect of the invention, in the control apparatus according to the eighth aspect of the invention, the electric-motor control portion is configured to cause the electric motor to output the predetermined torque, in a case in which the high-gear all-wheel driving mode is selected in the high-gear main-drive-wheel driving mode when each of the engine and the electric motor is in the stopped state.

According to a tenth aspect of the invention, in the control apparatus according to the first or second aspect of the invention, the engine control portion is configured, in the main-drive-wheel driving mode, to allow an engine intermittent operation in which the engine is placed alternately in an operated state and the stopped state, and is configured, in the all-wheel driving mode, to inhibit switching of the engine from the operated state to the stopped state.

In the control apparatus according to the first aspect of the invention, when the all-wheel driving mode is selected in the main-drive-wheel driving mode with the engine being in the stopped state, the engine control portion is configured to maintain the stopped state of the engine until the completion of the switching from the main-drive-wheel driving mode to the all-wheel driving mode by the driving-mode control portion, and to start the engine after the predetermined operation is executed by the driver of the vehicle to cause the vehicle to run. This control arrangement makes it possible to start the engine while preventing generation of a shock, by avoiding the switching to the all-wheel driving mode and the starting of the engine from being executed concurrently with each other. Further, the engine is started in response to the operation of the vehicle driver which leads to starting of the engine. It is therefore possible to make the driver of the vehicle hardly feel uncomfortable when the all-wheel driving mode is selected.

In the control apparatus according to the second aspect of the invention, the all-wheel driving mode is the driving mode in which the operation state of the engine is controlled such that the engine operation ratio is higher in the all-wheel driving mode than in the main-drive-wheel driving mode. Thus, also in the all-wheel driving mode in which the power performance is prioritized and the engine operation ratio is high, the engine can be kept in the stopped state until execution of the operation for causing the vehicle to actually run. This control arrangement makes it possible to achieve both an energy efficiency and a power performance.

In the control apparatus according to the third aspect of the invention, the predetermined operation is the acceleration requesting operation for increasing the drive power. Thus, the engine can be maintained in the stopped state until the driver's intention to start running of the vehicle or to accelerate the vehicle is confirmed. It is therefore possible to make the driver of the vehicle hardly feel uncomfortable, and to improve the energy efficiency.

In the control apparatus according to the fourth aspect of the invention, the predetermined operation is the acceleration requesting operation for increasing the drive power, wherein, in the case in which the switching operation is executed for switching from the state for selecting the non-driving position of the vehicle power transmission apparatus to the state for selecting the driving position of the vehicle power transmission apparatus, when the all-wheel driving mode is selected in the main-drive-wheel driving mode with the vehicle being stopped, the stopped state of the engine is maintained, and the engine is started when the acceleration requesting operation is executed after execution of the switching operation. Thus, the engine is not started only by a preparation operation that is to be executed, prior to the acceleration requesting operation, for causing the vehicle to actually run, and the engine can be maintained in the stopped state until the driver's intention to start running of the vehicle or to accelerate the vehicle is confirmed. Therefore, the energy efficiency can be improved.

In the control apparatus according to the fifth aspect of the invention, in the case in which the engine is in the stopped state when the main-drive-wheel driving mode is switched to the all-wheel driving mode, the predetermined torque causing the creep phenomenon is outputted from the electric motor. Therefore, it is possible to improve the energy efficiency while suppressing reduction of an acceleration responsiveness.

In the control apparatus according to the sixth aspect of the invention, in the case in which the main-drive-wheel driving mode is selected in the all-wheel driving mode when the predetermined torque is being outputted from the electric motor, the output torque of the electric motor form the predetermined torque is reduced toward zero after the predetermined time has elapsed from the completion of the switching from the all-wheel driving mode to the main-drive-wheel driving mode by the driving-mode control portion. This control arrangement makes it possible to improve the energy efficiency while suppressing reduction of the acceleration responsiveness after the switching to the main-drive-wheel driving mode.

In the control apparatus according to the seventh aspect of the invention, the output torque of the electric motor is reduced in the case in which the all-wheel driving mode is switched to the main-drive-wheel driving mode when the vehicle power transmission apparatus is in the non-driving position. Thus, the energy efficiency can be appropriately improved when the preparation operation is not executed for causing the vehicle to actually run.

In the control apparatus according to the eighth aspect of the invention, the predetermined torque causing the creep phenomenon is outputted from the electric motor in the case in which the engine is in the stopped state when the high-gear main-drive-wheel driving mode is switched to the high-gear all-wheel driving mode during stop of the vehicle. Thus, in the high-gear all-wheel driving mode, the rotation of the electric motor makes it easier to obtain rotation required by the operation of the dog clutch in the transmission provided in the drive-power distribution device. That is, in the high-gear all-wheel driving mode, it is possible to prepare for the switching to the low-gear all-wheel driving mode.

In the control apparatus according to the ninth aspect of the invention, the predetermined torque is outputted from the electric motor in the case in which the high-gear all-wheel driving mode is selected in the high-gear main-drive-wheel driving mode when each of the engine and the electric motor is in the stopped state. Thus, it is possible to reliably prepare for the switching to the low-gear all-wheel driving mode even when the engine is in the stopped state after the switching to the high-gear all-wheel driving mode.

In the control apparatus according to the tenth aspect of the invention, in the main-drive-wheel driving mode, the engine intermittent operation is allowed whereby the energy efficiency can be easily improved. On the other hand, in the all-wheel driving mode, the switching of the engine from the operated state to the stopped state is inhibited whereby the responsiveness of the drive power can be easily ensured. Further, in the all-wheel driving mode, it is possible to prevent a so-called “busy feel” that could be caused if the engine is switched to the operated state immediately after being switched to the stopped state.

### BRIEF DESCRIPTION OF THE DRAWINGS

FIG. 1 is a view schematically showing a construction of a vehicle to which the present invention is applied, for explaining major portions of control functions and control systems that are provided to perform various control operations in the vehicle;

FIG. 2 is a view schematically showing a construction of a transfer shown in FIG. 1;

FIG. 3 is a flow chart showing a main part of a control routine executed by an electronic control apparatus, namely, a control routine that is executed for making a driver of the vehicle hardly feel uncomfortable when an AWD mode is selected; and

FIG. 4 is a flow chart showing a main part of a control routine executed by the electronic control apparatus, namely, a control routine that is executed when the AWD mode is switched to a 2WD mode during output of a creep torque, wherein the control routine is different from that shown in FIG. 3.

### DETAILED DESCRIPTION OF PREFERRED EMBODIMENTS

Hereinafter, preferred embodiments of the invention will be described in detail with reference to the accompanying drawings.

### First Embodiment

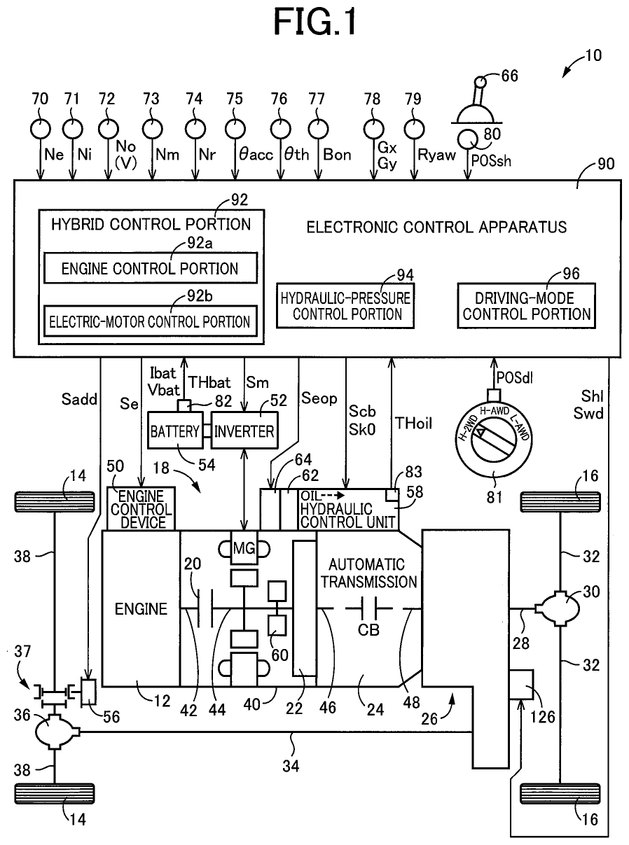

FIG. 1 is a view schematically showing a construction of a vehicle 10 to which the present invention is applied, for explaining major portions of control functions and control systems that are provided to perform various control operations in the vehicle 10. As shown in FIG. 1, the vehicle 10 is a hybrid electric vehicle including drive power sources in the form of an engine 12 and an electric motor MG. The vehicle 10 further includes right and left front wheels 14, right and left rear wheels 16 and a power transmission apparatus 18 that serves as a vehicle power transmission apparatus configured to transmit a drive power from the engine 12, for example, to the front wheels 14 and the rear wheels 16.

The vehicle 10 is an all-wheel drive vehicle based on a main-drive-wheel drive vehicle of FR (front engine and rear drive) system. The vehicle 10 is also a four-wheel drive vehicle based on a two-wheel drive vehicle of FR (front engine and rear drive) system, since the vehicle 10 has four wheels consisting of the two front wheels 14 and the two rear wheels 16. In the description of the present embodiment, a main-drive-wheel drive is synonymous with a two-wheel drive (=2WD), and an all-wheel drive (=AWD) is synonymous with a four-wheel drive (=4WD). The rear wheels 16 are main drive wheels serving as drive wheels during both of a 2WD running and an AWD running of the vehicle 10. The front wheels 14 are auxiliary drive wheels serving as driven wheels during the 2WD running and serving as the drive wheel during the AWD running. The 2WD running is a running in a 2WD state in which the drive power is transmitted to the rear wheels 16. The AWD running is a running in an AWD state in which the drive power is transmitted to the rear wheels 16 and the front wheels 14.

The engine 12 is a known internal combustion engine such as gasoline engine and diesel engine. The vehicle 10 is provided with an engine control device 50 that includes a throttle actuator, a fuel injection device and an ignition device. With the engine control device 50 being controlled by an electronic control apparatus 90 that is described below, an engine torque Te, which is an output torque of the engine 12, is controlled.

The electric motor MG is a rotating electric machine having a function serving as a motor configured to generate a mechanical power from an electric power and a function serving as a generator configured to generate an electric power from a mechanical power. That is, the electric motor MG is a so-called “motor generator”. The electric motor MG is connected to a battery 54 provided in the vehicle 10, through an inverter 52 provided in the vehicle 10. The battery 54 is an electric storage device configured to supply and receive an electric power to and from the electric motor MG. The inverter 52 is controlled by the electronic control apparatus 90 whereby an MG torque Tm as an output torque of the electric motor MG is controlled. The MG torque Tm serves as a power running torque when acting as a positive torque for acceleration, with the electric motor MG being rotated in a forward direction that is the same as a direction of rotation of the engine 12 during operation of the engine 12. The MG torque Tm serves as a regenerative torque when acting as a negative torque for deceleration, with the electric motor MG being rotated in the forward direction. The electric power corresponds to an electric energy unless they are to be distinguished from each other. The power corresponds to a torque and a force unless they are to be distinguished from one another.

The power transmission apparatus 18 includes a casing 40 as a non-rotary member that is attached to a body of the vehicle 10, a K0 clutch 20, a torque converter 22, an automatic transmission 24, a transfer 26, a rear propeller shaft 28, a rear differential device 30, right and left rear drive shafts 32, a front propeller shaft 34, a front differential device 36 and right and left front drive shafts 38, such that the K0 clutch 20, torque converter 22 and automatic transmission 24 are disposed inside the casing 40. The power transmission apparatus 18 further includes an engine connection shaft 42 and an electric-motor connection shaft 44 that disposed inside the casing 40. The engine connection shaft 42 connects between the engine 12 and the K0 clutch 20. The electric-motor connection shaft 44 connects between the K0 clutch 20 and the torque converter 22.

The K0 clutch 20 is a clutch disposed in a power transmission path between the engine 12 and the torque converter 22, so that the torque converter 22 is to be connected to the engine 12 through the K0 clutch 20. The automatic transmission 24 is disposed in a power transmission path between the torque converter 22 and the transfer 26, so that the torque converter 22 is connected to a transmission input shaft 46 that is an input rotary member of the automatic transmission 24, and the transfer 26 is connected to a transmission output shaft 48 that is an output rotary member of the automatic transmission 24.

In the casing 40, the electric motor MG is connected to the electric-motor connection shaft 44 in a power transmittable manner. That is, the electric motor MG is connected to a power transmission path between the K0 clutch 20 and the torque converter 22, in a power transmittable manner. From a different point of view, the electric motor MG is connected to the torque converter 22 and the automatic transmission 24 in a power transmittable manner, without through the K0 clutch 20.

The torque converter 20 is a fluid-type transmission device configured to transmit the drive power of the drive power sources in the form of the engine 12 and the electric motor MG, to the transmission input shaft 46, through fluid circulating in the torque converter 20. The automatic transmission 24 is a mechanical-type transmission device configured to transmit the drive power of the drive power sources in the form of the engine 12 and the electric motor MG, to the transfer 26.

The front differential device 36 is a differential device provided with an ADD (Automatic Disconnecting Differential) mechanism 37 that is constituted by, for example, a dog clutch serving as a connection/disconnection clutch. The front differential device 36 is placed in its locked state, with an operation state, i.e., a controlled state of the ADD mechanism 37 being placed in its engaged state. The front differential device 36 is placed in its free state, with the controlled state of the ADD mechanism 37 being placed in its released state. The controlled state of the ADD mechanism 37 is switched, with an ADD-mechanism actuator 56 (provided in the vehicle 10) being controlled by the electronic control apparatus 90.

The automatic transmission 24 is a known automatic transmission of a planetary gear type which includes at least one planetary gear device (not shown) and a plurality of engagement devices CB. Each of the engagement devices CB is a known hydraulically-operated frictional engagement device, for example. Each of the engagement devices CB receives a regulated CB hydraulic pressure PRcb supplied from a hydraulic control unit (hydraulic control circuit) 58 that is provided in the vehicle 10, whereby a CB torque Tcb, i.e., torque capacity is changed and its controlled state is switched between an engaged state and a released state, for example. The hydraulic control unit 58 is to be controlled by the electronic control apparatus 90.

The automatic transmission 24 is a step-variable automatic transmission configured to establish a selected one of a plurality of gear positions, with a corresponding one or ones of the engagement devices CB being engaged, wherein the gear positions are different from each other in gear ratio (speed ratios) γat (=AT input rotational speed Ni/AT output rotational speed No). The automatic transmission 24 is configured to switch from one of the AT gear positions to another one of the AT gear positions, namely, to establish one of the AT gear positions which is selected, by the electronic control apparatus 90, depending on, for example, an accelerating operation made by a vehicle driver (operator) and the vehicle running speed V. The AT input rotational speed Ni is a rotational speed of the transmission input shaft 46, and is an input rotational speed of the automatic transmission 24. The AT output rotational speed No is a rotational speed of the transmission output shaft 48, and is an output rotational speed of the automatic transmission 24.

The K0 clutch 20 is a hydraulically-operated frictional engagement device in the form of a multiple-disc type or a single-disc type clutch that is to be pressed by a hydraulic actuator, for example. The K0 clutch 20 receives a regulated K0 hydraulic pressure PRk0 supplied from the hydraulic control unit 58, whereby a K0 clutch torque Tk0, i.e., torque capacity of the K0 clutch 20 is changed and its operation state is switched between the engaged state and the released state, for example.

The transfer 26 is configured to selectively connect and cut-off a power transmission, for example, between the rear propeller shaft 28 and the front propeller shaft 34, so as to transmit the drive power transmitted from the automatic transmission 24, to only the rear wheels 16 or to the front and rear wheels 14, 16. Thus, the transfer 26 distributes the drive power to the rear wheels 16 as the main drive wheels and the front wheels 14 as the auxiliary drive wheels, with a ratio of distribution of the drive power between the main drive wheels and the auxiliary drive wheels being changeable.

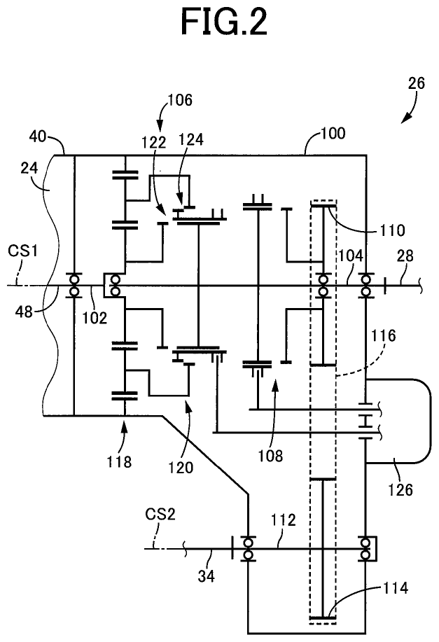

FIG. 2 is a view schematically showing a construction of the transfer 26, wherein the view is a development view illustrating the transfer 26 in a manner in which axes of an input shaft 102 and first and second output shafts 104, 112 are contained in a single plane. As shown in FIG. 2, the transfer 26 includes a non-rotary member in the form of a transfer casing 100 that is connected to one of opposite end portions of the casing 40, wherein the one of the opposite end portions is located on a rear side of the other of the opposite end portions in a direction of running of the vehicle 10. The transfer 26 further includes the input shaft 102, the first output shaft 104, an auxiliary transmission 106, a power-distribution dog clutch 108 and a drive gear 110 which are provided inside the transfer casing 100 and which are disposed on a common axis in the form of a first axis CS1. The transfer 26 further includes the second output shaft 112 and a driven gear 114 which are provided inside the transfer casing 100 and which are disposed on another common axis in the form of a second axis CS2. The transfer 26 further includes a chain 116 connecting between the drive gear 110 and the driven gear 114.

The input shaft 102 is connected to the transmission output shaft 48. The first output shaft 104 is connected to the rear propeller shaft 28. The second output shaft 112 is connected to the front propeller shaft 34. The drive gear 110 is selectively allowed to be rotated relative to the first output shaft 104, and inhibited from being rotated relative to the first output shaft 104. The driven gear 114 is unrotatable relative to the second output shaft 112.

The auxiliary transmission 106 includes a planetary gear device 118 and an auxiliary-transmission dog clutch 120 that includes a high-gear-side dog mechanism 122 and a low-gear-side dog mechanism 124. The high-gear-side dog mechanism 122 is provided to establish a high gear position GSH providing a low gear ratio and making the vehicle 10 run at a high running speed. The low-gear-side dog mechanism 124 is provided to establish a low gear position GSL providing a high gear ratio and making the vehicle 10 run at a low running speed. Each of the high-gear-side dog mechanism 122 and the low-gear-side dog mechanism 124 is constituted by a dog clutch provided with a synchronous meshing mechanism, for example. That is, the auxiliary transmission 106 is a transmission configured to establish a selected one of the low gear position GSL and the high gear position GSH, which is selected depending on an operation of the auxiliary-transmission dog clutch 120 as a dog clutch. The transfer 26 is configured to transmit rotation of the input shaft 102 to the first output shaft 104 through the auxiliary transmission 106.

The power-distribution dog clutch 108 is an engagement device configured to selectively allow the drive gear 110 to be rotated relative to the first output shaft 104 and inhibit the drive gear 110 from being rotated relative to the first output shaft 104. The power-distribution dog clutch 108 is a dog clutch provided with a synchronous meshing mechanism, for example. With the power-distribution dog clutch 108 being placed in its released state, the drive gear 110 is rotatable about the first axis CS1 relative to the first output shaft 104, whereby the power transmission between the first and second output shafts 104, 112 through the drive gear 110, chain 116 and driven gear 114, for example, is disabled. With the power-distribution dog clutch 108 being placed in its engaged state, the drive gear 110 is inhibited from being rotated about the first axis CS1 relative to the first output shaft 104, whereby the power transmission between the first and second output shafts 104, 112 through the drive gear 110, chain 116 and driven gear 114, for example, is enabled.

The transfer 26 further includes a shift actuator 126 fixed to the transfer casing 100. The shift actuator 126 is an actuator configured to operate the auxiliary-transmission dog clutch 120 and the power-distribution dog clutch 108.

Referring back to FIG. 1, when the power-distribution dog clutch 108 is placed in the engaged state in the transfer 26 and the ADD mechanism 37 is placed in the engaged state in the front differential device 36, a part of the drive power is transmitted to the second output shaft 112 through the transfer 26, and is transmitted to the front differential device 36 through the front propeller shaft 34, so that the part of the drive power is transmitted eventually to the front wheels 14 through the front drive shafts 38. Meanwhile, the remainder of the drive power, which is not transmitted to the second output shaft 112 through the transfer 26, is transmitted to the rear differential device 30 through the rear propeller shaft 28, and is transmitted eventually to the rear wheels 16 through the rear drive shafts 32. Thus, the vehicle 10 is placed in the AWD state.

On the other hand, when the power-distribution dog clutch 108 is placed in the released state in the transfer 26, the drive power is transmitted through the transfer 26 only to the rear wheels 16, so that the vehicle 10 is placed in the 2WD state. In the vehicle 10, the ADD mechanism 37 is placed in the released state, for example, when the vehicle 10 is placed in the 2WD state.

In the vehicle 10, when the K0 clutch 20 is placed in the engaged state, the engine 12 and the torque converter 22 are connected to each other in a power transmittable manner. On the other hand, when the K0 clutch 20 is placed in the released state, the power transmission between the engine 12 and the torque converter 22 is cut off. Since the electric motor MG is connected to the torque converter 22, the K0 clutch 20 serves as a clutch configured to selectively connect and disconnect the engine 12 to and from the electric motor MG.

In the power transmission apparatus 18, when the K0 clutch 20 is in the engaged state, the drive power outputted by the engine 12 is transmitted from the engine connection shaft 42 to the transfer 26 through sequentially the K0 clutch 20, electric-motor connection shaft 44, torque converter 22 and automatic transmission 24, for example. Meanwhile, the drive power outputted by the electric motor MG is transmitted from the electric-motor connection shaft 44 to the transfer 26 sequentially the torque converter 22 and automatic transmission 24, for example, irrespective of the controlled state of the K0 clutch 20. The drive power, which has been transmitted to the transfer 26, is further transmitted from the transfer 26 to the rear wheels 16 when the vehicle 10 is in the 2WD state, and is further transmitted from the transfer 26 to the front wheels 14 as well as to the rear wheels 16 when the vehicle 10 is in the AWD state.

The vehicle 10 further includes an MOP 60 that is a mechanically-operated oil pump, an EOP 62 that is an electrically-operated oil pump, and a pump motor 64. The MOP 60 is connected to the electric-motor connection shaft 44, and is to be rotated and driven by the drive power source or sources (i.e., engine 12 and/or electric motor MG), so as to output a working fluid OIL that is to be used in the power transmission apparatus 18. The pump motor 64 is a motor serving exclusively to rotate and drive the EOP 62. The EOP 62 outputs the working fluid OIL, when being rotated and driven by the pump motor 64. The working fluid OIL outputted by the MOP 60 and the EOP 62 is supplied to the hydraulic control unit 58. The hydraulic control unit 58, which receives the working fluid OIL as an original hydraulic pressure, supplies regulated hydraulic pressures that serve as the CB hydraulic pressure PRcb and the K0 hydraulic pressure PRk0, for example.

The vehicle 10 is further provided with the electronic control apparatus 90 which is constructed according to the present invention and which is related to control of the engine 12, for example. The electronic control apparatus 90 includes a so-called microcomputer incorporating a CPU, a ROM, a RAM and an input-output interface. The CPU performs various control operations of the vehicle 10, by processing various input signals, according to control programs stored in the ROM, while utilizing a temporary data storage function of the RAM. The electronic control apparatus 90 may be constituted by two or more control units exclusively assigned to perform respective different control operations such as an engine control operation, an electric-motor control operation and a hydraulic-pressure control operation, as needed.

The electronic control apparatus 90 receives various input signals based on values detected by respective sensors provided in the vehicle 10. Specifically, the electronic control apparatus 90 receives: an output signal of an engine speed sensor 70 indicative of an engine rotational speed Ne that is a rotational speed of the engine 12; an output signal of an input speed sensor 71 indicative of the AT input rotational speed Ni; an output signal of an output speed sensor 72 indicative of the AT output rotational speed No corresponding to the vehicle running speed V; an output signal of an MG speed sensor 73 indicative of an MG rotational speed Nm that is a rotational speed of the electric motor MG; an output signal of a wheel speed sensor 74 indicative of a wheel speed Nr that is a rational speed of each of the front and rear wheels 14, 16; an output signal of an accelerator-opening degree sensor 75 indicative of an accelerator opening degree (accelerator operation degree) θacc representing an amount of accelerating operation made by the vehicle driver; an output signal of a throttle-opening degree sensor 76 indicative of a throttle opening degree θth which is an opening degree of an electronic throttle valve; an output signal of a brake pedal sensor 77 indicative of the braking operation amount Bra and also a brake ON signal representing a state in which the brake pedal is being operated by the vehicle driver so as to operate the wheel brakes; an output signal of a G sensor 78 indicative of a longitudinal acceleration Gx and a lateral acceleration Gy of the vehicle 10; an output signal of a yaw rate sensor 79 indicative of a yaw rate Ryaw that is an angular acceleration of the vehicle 10 about its vertical axis; an output signal of a shift position sensor 80 indicative of a shift operation position POSsh that is an operation position of a shift lever 66 provided in the vehicle 10; an output signal of a driving-state selection dial switch 81 indicative of a dial-switch operation position POSdl that is an operation position of driving-state selection dial switch 81; an output signal of a battery sensor 82 indicative of a battery temperature THbat, a battery charging/discharging electric current Ibat and a battery voltage Vbat of the battery 54; and an output signal of a fluid temperature sensor 83 indicative of a working-fluid temperature THoil that is a temperature of the working fluid OIL.

The shift lever 66 is a shift operation member for permitting the vehicle driver to manually select one of a plurality of shift positions in the power transmission apparatus 18, particularly, in the automatic transmission 24. The shift lever 66 is to be operated, by the vehicle driver, to be placed in the shift operation position POSsh corresponding to the selected one of the shift positions in the power transmission apparatus 18 or in the automatic transmission 24 (hereinafter simply referred to as “the shift positions in the automatic transmission 24”). The shift lever 66 is to be placed in one of a plurality of operation positions as the shift operation position POSsh, wherein the plurality of operation positions include P, R, N and D operation positions, for example.

The P operation position is for selecting a parking position (=P position) as one of the shift positions in the automatic transmission 24. When the P position is established in the automatic transmission 24, the automatic transmission 24 is placed in its neutral state and rotation of the transmission output shaft 48 is mechanically inhibited. The neutral state of the automatic transmission 24 is a state in which the drive power is not transmittable through the automatic transmission 24, and is realized by cutting off the power transmission through the automatic transmission 24, for example, with any one of the engagement devices CB being placed in the released state. The mechanical inhibition of rotation of the transmission output shaft 48 is made by a known parking lock mechanism provided in the vehicle 10. That is, the automatic transmission 24 is placed in its parking lock state, when the P position is established in the automatic transmission 24. The R operation position is a reverse-driving operation position for selecting a reverse driving position (=R position) as one of the shift positions in the automatic transmission 24. When the R position is established in the automatic transmission 24, the vehicle 10 is enabled to run in reverse direction. The N operation position is a neutral operation position for selecting a neutral position (=N position) as one of the shift positions in the automatic transmission 24. When the N position is established in the automatic transmission 24, the automatic transmission 24 is placed in the neutral state, so that the transmission output shaft 48 is not mechanically unrotatably fixed whereby the power transmission through the automatic transmission 24 is disabled. The D operation position is a forward-driving operation position for selecting a forward driving position (=D position) as one of the shift positions in the automatic transmission 24. When the D position is established in the automatic transmission 24, the vehicle 10 is enabled to run in forward direction with an automatic shift control being executed for the automatic transmission 24. That is, when the D position is established in the automatic transmission 24, the drive power causing the vehicle 10 to run in the forward direction can be transmitted through the automatic transmission 24. When either the P position or the N position is established in the automatic transmission 24, the automatic transmission 24 is placed in its non-driving position that disables transmission of the drive power. When either the R position or the D position is established in the automatic transmission 24, the he automatic transmission 24 is placed in its driving position that enables transmission of the drive power.

The driving-state selection dial switch 81 is disposed in the vicinity of the driver's seat, for example, and is a dial switch that is to be operated by the vehicle driver for selecting a driving state of the vehicle 10. The driving-state selection dial switch 81 is to be placed in one of three operation positions consisting of “H-2WD”, “H-AWD” and “L-AWD”, for example. When the driving-state selection dial switch 81 is placed in “H-2WD”, a high-gear 2WD mode is selected as one of the driving modes. When the driving-state selection dial switch 81 is placed in “H-AWD”, a high-gear AWD mode is selected as one of the driving modes. When the driving-state selection dial switch 81 is placed in “L-AWD”, a low-gear AWD mode is selected as one of the driving modes. The high-gear 2WD mode is a driving mode in which the vehicle 10 is placed in the 2WD state as the driving state with the auxiliary transmission 106 of the transfer 26 being placed in the high gear position GSH. In the 2WD mode in which the drive power is distributed only to the rear wheels 16, the auxiliary transmission 106 is basically placed in the high gear position GSH. That is, in the present embodiment, the 2WD mode is the high-gear 2WD mode. The high-gear AWD mode is a driving mode in which the vehicle 10 is placed in the AWD state as the driving state with the auxiliary transmission 106 being placed in the high gear position GSH. The low-gear AWD mode is a driving mode in which the vehicle 10 is placed in the AWD state as the driving state with the auxiliary transmission 106 being placed in the low gear position GSL. In the present embodiment, an AWD mode (in which the drive power is distributed to the front wheels 14 as well as to the rear wheels 16) is categorized into the low-gear AWD mode and the high-gear AWD mode. It is noted that the driving-state selection dial switch 81 does not necessarily have to be the dial switch but may be a slide button or a seasaw button, for example.

The electronic control apparatus 90 generates various output signals to the various devices provided in the vehicle 10, such as: an engine control command signal Se that is to be supplied to the engine control device 50 for controlling the engine 12, an MG control command signal Sm that is to be supplied to the inverter 52 for controlling the electric motor MG; an ADD-switch control command signal Sadd that is to be supplied to the ADD-mechanism actuator 56 for switching a controlled state of the ADD mechanism 37; a CB hydraulic command signal Scb that is to be supplied to the hydraulic control unit 58 for controlling the engagement devices CB; a K0 hydraulic command signal Sk0 that is to be supplied to the hydraulic control unit 58 for controlling the K0 clutch 20; an EOP control command signal Seop that is to be supplied to the pump motor 64 for controlling operation of the EOP 62; a high/low switching control signal Shl that is to be supplied to the shift actuator 126 for switching the auxiliary transmission 106 between the high gear position GSH and the low gear position GSL; and a driving-state switching control signal Swd that is to be supplied to the shift actuator 126 for controlling the transfer 26 so as to switch the vehicle 10 between the 2WD state and the AWD state.

For performing various control operations in the vehicle 10, the electronic control apparatus 90 includes a hybrid control means in the form of a hybrid control portion 92, a hydraulic-pressure control means in the form of a hydraulic-pressure control portion 94, and a driving mode control means in the form of a driving-mode control portion 96.

The hybrid control portion 92 has a function serving as an engine control means in the form of an engine control portion 92a for controlling operation of the engine 12 and a function serving as an electric-motor control means in the form of an electric-motor control portion 92b for controlling operation of the electric motor MG through the inverter 52, and executes a hybrid-drive control operation, for example, using the engine 12 and the electric motor MG through these control functions.

The hybrid control portion 92 calculates a requested drive amount of the vehicle 10 requested by the vehicle driver, by applying the accelerator opening degree θacc and the vehicle running speed V, for examples, to a requested drive amount map that represents a pre-stored relationship obtained by experimentation or determined by an appropriate design theory. The requested drive amount is, for example, a requested drive torque Trdem of the drive wheels (rear wheels 16 and front wheels 14). From another point of view, the requested drive torque Trdem [Nm] is a requested drive power Prdem [W] at the current vehicle running speed V. As the requested drive amount, another value such as a requested drive force Frdem [N] of the drive wheels 14 and a requested AT output torque of the transmission output shaft 48 may be used, too. In the calculation of the requested drive amount, it is also possible to use, for example, the AT output rotational speed No in place of the vehicle running speed V.

The hybrid control portion 92 outputs the engine control command signal Se and the MG control command signal Sm for controlling the engine 12 and the electric motor MG, respectively, such that the requested drive power Prdem is realized, by taking account of various factors such as a transmission loss, an auxiliary load, the gear ratio γat of the automatic transmission 24 and a maximum chargeable amount Win and a maximum dischargeable amount Wout of the battery 54. The engine control command signal Se is, for example, a command value of an engine power Pe that is the power of the engine 12 outputting the engine torque Te at the current engine rotational speed Ne. The MG control command signal Sm is, for example, a command value of a consumed electric power Wm of the electric motor MG outputting the MG torque Tm at the current motor rotational speed Nm.

The maximum chargeable amount Win of the battery 54 is a maximum amount of the electric power that can be charged to the battery 54, and represents a limitation of the electric power inputted to the battery 54, namely, a limitation of input to the battery 54. The maximum dischargeable amount Wout of the battery 54 is a maximum amount of the electric power that can be discharged from the battery 54, and represents a limitation of the electric power outputted from the battery 54, namely, a limitation of output of the battery 54. The maximum chargeable and dischargeable amounts Win, Wout are calculated by the electronic control apparatus 90, for example, based on the battery temperature THbat and a state-of-charge value SOC [%] of the battery 54. The state-of-charge value SOC of the battery 54 is a value indicative of a charged state of the battery 54, i.e., an amount of the electric power stored in the battery 54, and is calculated by the electronic control apparatus 90, for example, based on the charging/discharging electric current Ibat and the voltage Vbat of the battery 54.

When the requested drive torque Trdem can be covered by only the output of the electric motor MG, the hybrid control portion 92 establishes a motor driving (=EV driving) mode as one of the driving modes. When the EV driving mode is established, the hybrid control portion 92 causes the vehicle 10 to perform an EV driving with the K0 clutch 20 being released and with only the electric motor MG serving as the drive power sourceOn the other hand, when the requested drive torque Trdem cannot be covered without at least the output of the engine 12, the hybrid control portion 92 establishes an engine driving mode, i.e., a hybrid driving (=HV driving) mode. When the HV driving mode is established, the hybrid control portion 92 causes the vehicle 10 to perform an engine driving, i.e., an HV driving with the K0 clutch 20 being engaged and with at least the engine 12 serving as the drive power source. Further, even when the requested drive torque Trdem can be covered by only the output of the electric motor MG, the hybrid control portion 92 establishes the HV driving mode, for example, in a case in which the state-of-charge value SOC of the battery 54 becomes less than a predetermined engine-start threshold value SOCengf or in a case in which the engine 12 or other component needs to be warmed up. The engine-start threshold value is a predetermined threshold value for determining that the state-of-charge value SOC reaches a level at which the engine 12 must forcibly be started for charging the battery 54. Thus, the hybrid control portion 92 switches between the EV driving mode and the HV driving mode, based on, for example, the requested drive torque Trdem, by automatically stopping the engine 12 during the HV driving, restarting the engine 12 after the stop of the engine 12, and starting the engine 12 during the EV driving.

The engine control portion 92a is configured to determine whether the starting of the engine 12 is requested (required) or not. The engine control portion 92a determines whether the starting of the engine 12 is requested or not, for example, depending on (i) whether the requested drive torque Trdem has become larger than a range that can be covered by only the output of the electric motor MG, (ii) whether the engine 12 or other component needs to be warmed up and (iii) whether the state-of-charge value SOC of the battery 57 has become less than the engine-start threshold value SOCengf.

When it is determined by the engine control portion 92a that the starting of the engine 12 is requested, the hydraulic-pressure control portion 94 outputs the K0 hydraulic command signal Sk0 that is supplied to the hydraulic control unit 58, wherein the hydraulic command signal Sk0 requests the K0 clutch 20 to be switched from the released state to the engaged state, for thereby obtaining the K0 torque Tk0 that enables transmission of a torque required for cranking of the engine 12, i.e., a torque by which the engine rotational speed Ne to be increased. In the following description of the present embodiment, the torque required for cranking of the engine 12 will be referred to as “required cranking torque Tcrn”.

When it is determined by the engine control portion 92a that the starting of the engine 12 is requested, the electric-motor control portion 92b outputs the MG control command signal Sm that is supplied to the inverter 52, wherein the MG control command signal Sm requests the electric motor MG to output the required cranking torque Tcrn concurrently with switching of the K0 clutch 20 from the released state to the engaged state by the hydraulic-pressure control portion 94.

When determining that the starting of the engine 12 is requested, the engine control portion 92a outputs the engine control command signal Se that is supplied to the engine control device 50, wherein the engine control command signal Se requests fuel supply and engine ignition to be initiated in conjunction with the cranking of the engine 12 that is made by the K0 clutch 20 and the electric motor MG.

When the engine 12 is to be started during the EV driving, the electric-motor control portion 92b causes the electric motor MG to output the MG torque Tm corresponding to the required cranking torque Tcrn, in addition to the MG torque Tm for the EV driving, i.e., the MG torque Tm serving as the drive torque Tr. To this end, during the EV driving, the required cranking torque Tcrn needs to be available or assured in preparation for starting the engine 12. Therefore, when the engine 12 is to be started, the requested drive torque Trdem can be covered by only the output of the electric motor MG, when the requested drive torque Trdem is not larger than a torque value obtained by subtracting the required cranking torque Tcrn from an outputtable maximum torque of the electric motor MG. The outputtable maximum torque of the electric motor MG is an outputtable maximum value of the motor torque Tm which is dependent on the maximum dischargeable amount Wout of the battery 54.

The engine control portion 92a makes a determination as to whether the stop of the engine 12 is requested or not. This determination is made by the engine control portion 92a during the HV driving mode, depending on, for example, (i) whether the requested drive torque Trdem can be covered by only the output of the electric motor MG, (ii) whether the engine 12 or other components are unrequired to be warmed, and (iii) whether the state-of-charge value SOC of the battery 54 is at least the engine-start threshold value SOCengf.

When determining that the stop of the engine 12 is requested, the engine control portion 92a supplies, to the engine control device 50, the engine control command signal Se requesting stop of the fuel supply to the engine 12. That is, when the engine 12 is to be stopped, the engine control portion 92a supplies, to the engine control device 50, the engine control command signal Se by which the engine 12 is to be controlled to be stopped.

When it is determined by the engine control portion 92a that the stop of the engine 12 is requested, the hydraulic-pressure control portion 94 supplies, to the hydraulic control unit 58, the K0 hydraulic command signal Sk0 by which the K0 clutch 20 is to be controlled to be switched from the engaged state to the released state.

Thus, the engine control portion 92a controls the operation state of the engine 12, so as to start and stop the engine 12, depending on the currently established driving mode and the current state of the vehicle 10.

The hydraulic-pressure control portion 94 determines whether a shifting action is to be executed in the automatic transmission 24, by using, for example, a shifting map that represents a predetermined relationship, and outputs the CB hydraulic command signal Scb, as needed, which is supplied to the hydraulic control unit 58, for executing the shifting action in the automatic transmission 24. In the shifting map, the predetermined relationship is represented by shifting lines in two-dimensional coordinates in which the vehicle running speed V and the requested drive torque Trdem as two variables are taken along respective two axes, wherein the shifting lines are used for the determination as to whether the shifting action is to be executed in the automatic transmission 24. In the shifting map, one of the two variables may be the AT output rotational speed No in place of the vehicle running speed V, and the other of the two variables may be any one of the requested drive force Frdem, accelerator opening degree θacc and throttle opening degree θth in place of the requested drive torque Trdem.

The driving-mode control portion 96 controls running of the vehicle 10 so as to realize selected at least one of the driving modes which is selected by the vehicle driver. Specifically, the driving modes include the 2WD mode (i.e., high-gear 2WD mode) and the AWD mode, wherein the AWD mode is categorized into the low-gear AWD mode and the high-gear AWD mode.

When the high-gear 2WD mode is selected by the driving-state selection dial switch 81, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the high gear position GSH to be established in the auxiliary transmission 106, the driving-state switching control signal Swd requests the power-distribution dog clutch 108 to be placed in the released state, and the ADD-switch control command signal Sadd requests the ADD mechanism 37 to be placed in the released state.

When the high-gear AWD mode is selected by the driving-state selection dial switch 81, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the high gear position GSH to be established in the auxiliary transmission 106, the driving-state switching control signal Swd requests the power-distribution dog clutch 108 to be placed in the engaged state, and the ADD-switch control command signal Sadd requests the ADD mechanism 37 to be placed in the engaged state.

When the low-gear AWD mode is selected by the driving-state selection dial switch 81, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the low gear position GSL to be established in the auxiliary transmission 106, the driving-state switching control signal Swd requests the power-distribution dog clutch 108 to be placed in the engaged state, and the ADD-switch control command signal Sadd requests the ADD mechanism 37 to be placed in the engaged state.

In the AWD mode, a larger drive force Fr is likely to be required as compared with in the 2WD mode. In the HV driving mode in which the engine 12 is in its operated state, a larger drive force Fr is available easier than in the EV driving mode. Therefore, when the AWD mode is selected in a stopped state of the engine 12, it is conceivable to start the engine 12 so as to pace the engine 12 into the operated state. The operation state of the engine 12 is controlled by the engine control portion 92a such that an engine operation ratio Reng of the engine 12 is higher in the AWD mode than in the 2WD mode, wherein the engine operation ratio Reng is a ratio of an operation time of the engine 12 to an operation time of the vehicle 10. The operation time of the vehicle 10 is a time for which a main power-supply switch of the vehicle 10 is placed in its ON state, and corresponds to a sum of the operation time of the engine 12 and a stop time of the engine 12. The operation time of the vehicle 10 may be referred also to as “power-ON time of the vehicle 10”. The operation time of the engine 12 is a time for which the engine 12 is in its operated state during the operation time of the vehicle 10. The stop time of the engine 12 is a time for which the engine 12 is in its stopped state during the operation time of the vehicle 10.

However, when the vehicle driver selects the AWD mode, there is a possibility that the vehicle driver does not necessarily have an intention to start the engine 12. Further, if the engine 12 is started immediately when the AWD mode is selected, there is a possibility that switching from the 2WD mode to the AWD mode could be executed concurrently with starting of the engine 12, thereby causing a shock in the vehicle 10. It is desirable to make the vehicle driver hardly feel uncomfortable when the AWD mode is selected.

Therefore, in the present embodiment, in a case in which the AWD mode is selected in the 2WD mode with the engine 12 being in the stopped state, the engine control portion 92a does not start the engine 12 immediately when the AWD mode is selected. When the AWD mode is selected in the 2WD mode, the engine control portion 92a starts the engine 12, when the vehicle driver executes an operation that makes the vehicle driver feel hardly uncomfortable even with the engine 12 being started.

That is, in a case in which the AWD mode is selected in the 2WD mode when the engine 12 is in the stopped state, the engine control portion 92a maintains the stopped state of the engine 12 until the completion of switching from the 2WD mode to the AWD mode by the driving-mode control portion 96, and starts the engine 12 after a predetermined operation AMf by the vehicle driver to drive the vehicle 10 (namely, to cause the vehicle 10 to run).

For switching between the high-gear 2WD mode and the low-gear AWD mode, it is necessary to switch between the high gear position GSH and the low gear position GSL and to switch between the 2WD mode and the AWD mode. Therefore, it is not preferable to switch directly between the high-gear 2WD mode and the low-gear AWD mode. Therefore, in the present embodiment, switching between the high-gear 2WD mode and the high-gear AWD mode is executed as an example of the switching between the 2WD mode and the AWD mode.

The above-described predetermined operation AMf is an operation that makes it possible to confirm the vehicle driver's intention to start running of the vehicle 10 and accelerate the vehicle 10, and is, for example, an acceleration requesting operation that increases the drive force Fr. The acceleration requesting operation is, for example, an accelerating operation that increases the requested drive force Frdem. A switching operation for switching from a state for selecting the non-driving position of the automatic transmission 24 to a state for selecting the driving position of the automatic transmission 24, is a preparation operation that is to be executed, prior to the acceleration requesting operation, for causing the vehicle 10 to actually run. Therefore, this switching operation does not correspond to the predetermined operation AMf. The above-described state for selecting the non-driving position of the automatic transmission 24 is a state in which the shift lever 66 is placed in the P operation position or N operation position as the shift operation position POSsh. The above-described state for selecting the driving position of the automatic transmission 24 is a state in which the shift lever 66 is placed in the D operation position or R operation position as the shift operation position POSsh. That is, the above-described switching operation is an operation for switching from the N operation position or P operation position, to the D operation or R operation position. In the following description, this operation (for switching from the N operation position or P operation position, to the D operation or R operation position) will be referred simply to as “N(P)→D(R) operation”.

In a case in which the N(P)→D(R) operation is executed when the high-gear AWD mode is selected in the high-gear 2WD mode with the engine 12 being in the stopped state during stop of the vehicle 10, the engine control portion 92a maintains the stopped state of the engine 12, and starts the engine 12 when the acceleration requesting operation is executed after execution of the N(P)→D(R) operation.

For switching between the high-gear AWD mode and the low-gear AWD mode, the switching operation of the auxiliary-transmission dog clutch 120 is required in the auxiliary transmission 106. For the switching operation of the auxiliary-transmission dog clutch 120, the input shaft 102 and other rotary members are required to be rotated to some extent. When the auxiliary-transmission dog clutch 120 is to be switched between the high-gear AWD mode and the low-gear AWD mode, the engine 12 is required to be in the operated state, or the electric motor MG is required to be rotated. Further, from another point of view, it is desirable that the drive power is readily available from the engine 12 or the electric motor MG, so as not to reduce an acceleration responsiveness, i.e., a responsiveness of the drive force Fr in the AWD mode. To this end, in the AWD mode, the electric motor MG is placed in its rotated state when the engine 12 is in its stopped state. Therefore, in a case in which the engine 12 is kept in the stopped state when the high-gear 2WD mode is switched to the high-gear AWD mode, the electric motor MG is placed in the rotated state.

When the engine 12 is in the stopped state upon switching from the high-gear 2WD mode to the high-gear AWD mode, the electric-motor control portion In the MG idling control, the electric motor MG is controlled to output a predetermined torque causing a creep phenomenon in which the vehicle 10 is moved slowly with the accelerator being kept OFF, upon release of the brake pedal during a temporary stop of the vehicle 10 when the engine 12 is in the stopped state with the accelerator being OFF. 92b executes an MG idling control for idling the electric motor MG, for example. The MG idling control is a control for placing the electric motor MG into an idle state in which the MG rotational speed Nm is kept at an MG idle speed that is a predetermined idling rotational speed of the electric motor MG. The MG idling control is a control that is to be executed, for example, when the accelerator being kept OFF with the engine 12 being in the stopped state, to cause the electric motor MG to output a predetermined torque causing a creep phenomenon in which the vehicle 10 is moved slowly, with the accelerator being kept OFF. In the MG idling control, the electric motor MG is controlled to output a predetermined torque causing a creep phenomenon in which the vehicle 10 is moved slowly with the accelerator being kept OFF, upon release of the brake pedal during a temporary stop of the vehicle 10 when the engine 12 is in the stopped state with the accelerator being OFF. The predetermined torque is a creep toque that causes the vehicle 10 to perform a so-called creep running, for example, when the brake pedal is released with the accelerator being kept OFF during the stopped state of the vehicle 10. The engine 12 is required to be in the operated state, or the electric motor MG is required to be rotated, upon switching between the high-gear AWD mode and the low-gear AWD mode, particularly, in a state in which the vehicle 10 is stopped. The MG idling control is executed, by the electric-motor control portion 92b, in the state in which the vehicle 10 is stopped.

The electric-motor control portion 92b executes the MG idling control for causing the electric motor MG to output the creep torque, in a case in which the high-gear AWD mode is selected in the high-gear 2WD mode when each of the engine 12 and the electric motor MG is in the stopped state.

Specifically, the engine control portion 92a determines whether the engine 12 is in the stopped state or not.

When it is determined by the engine control portion 92a that the engine 12 is in the stopped state, the driving-mode control portion 96 determines whether the high-gear 2WD mode as one of the driving modes is established or not. When determining that the high-gear 2WD mode is established, the driving-mode control portion 96 determines whether the high-gear AWD mode is selected or not, based on the dial-switch operation position POSdl.

When determining that the high-gear AWD mode is selected, the driving-mode control portion 96 executes switching from the high-gear 2WD mode to the high-gear AWD mode. Then, the driving-mode control portion 96 determines whether the switching from the high-gear 2WD mode to the high-gear AWD mode has been completed or not.

The electric-motor control portion 92b causes the electric motor MG to output the creep torque, if the electric motor MG is in the stopped state when the high-gear 2WD mode is switched to the high-gear AWD mode with the engine 12 being kept in the stopped state.

When it is determined by the driving-mode control portion 96 that the switching from the high-gear 2WD mode to the high-gear AWD mode has been completed, the engine control portion 92a determines whether the acceleration requesting operation as the predetermined operation AMf has been executed or not. When determining that the acceleration requesting operation has been executed, the engine control portion 92a starts the engine 12.

In the high-gear 2WD mode, the energy efficiency is prioritized as compared with in the AWD mode. Therefore, in the high-gear 2WD mode, it is desirable that the EV driving mode and the HV driving mode are alternately switched to each other by execution of an engine intermittent operation in which the engine 12 is placed alternately in the operated state and the stopped state. On the other hand, in the AWD mode, the responsiveness of the drive force Fr is prioritized as compared with in the high-gear 2WD mode. Therefore, in the AWD mode, once after the engine 12 is placed into the operated state, it is desirable that the engine intermittent operation is inhibited so as not to place the engine 12 into the stopped state. In the high-gear 2WD mode, the engine control portion 92a allows the engine intermittent operation. On the other hand, in the AWD mode, the engine control portion 92a inhibits switching of the engine 12 from the operated state to the stopped state.

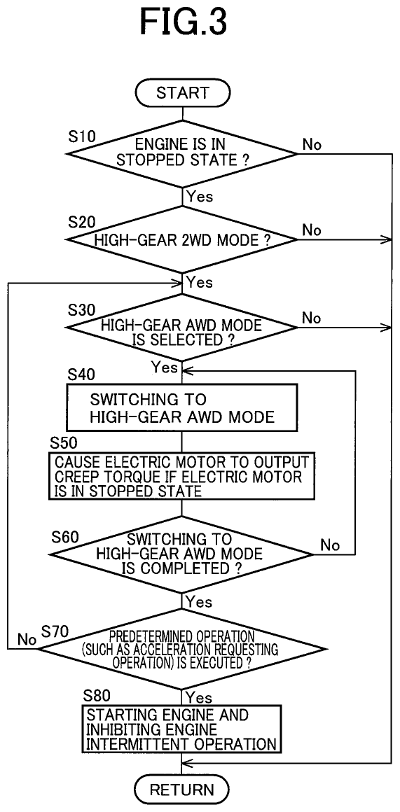

FIG. 3 is a flow chart showing a main part of a control routine executed by the electronic control apparatus 90, namely, a control routine that is executed for making the vehicle driver hardly feel uncomfortable when the AWD mode is selected. This control routine is executed, for example, in a repeated manner.

As shown in FIG. 3, the control routine is initiated with step S10 corresponding to function of the engine control portion 92a, which is implemented to determine whether the engine 12 is in the stopped state or not. When a negative determination is made at step S10, one cycle of execution of the control routine is terminated. When an affirmative determination is made at step S10, step S20 corresponding to function of the driving-mode control portion 96 is implemented to determine whether the high-gear 2WD mode as one of the driving modes is established or not. When a negative determination is made at step S20, one cycle of execution of the control routine is terminated. When an affirmative determination is made at step S20, step S30 corresponding to function of the driving-mode control portion 96 is implemented to determine whether the high-gear AWD mode is selected or not. When a negative determination is made at step S30, one cycle of execution of the control routine is terminated. When an affirmative determination is made at step S30, step S40 corresponding to function of the driving-mode control portion 96 is implemented to switch from the high-gear 2WD mode to the high-gear AWD mode. Step S40 is followed by step S50 corresponding to function of the electric-motor control portion 92b, which is implemented to cause the electric motor MG to output the creep torque if the electric motor MG is in the stopped state. Step S50 is followed by step S60 corresponding to function of the driving-mode control portion 96, which is implemented to determine whether the switching from the high-gear 2WD mode to the high-gear AWD mode has been completed or not. When a negative determination is made at step S60, the control flow goes back to step S40. When an affirmative determination is made at step S60, step S70 corresponding to function of the engine control portion 92a is implemented to determine whether the acceleration requesting operation as the predetermined operation AMf has been executed or not. When a negative determination is made at step S70, the control flow goes back to step S30. When an affirmative determination is made at step S70, step S80 corresponding to function of the engine control portion 92a is implemented to start the engine 12 and to inhibit the engine intermittent operation so as to inhibit switching of the engine 12 from the operated state to the stopped state.

As described above, in the present embodiment, when the AWD mode is selected in the 2WD mode with the engine 12 being in the stopped state, the stopped state of the engine 12 is maintained until the completion of the switching from the 2WD mode to the AWD mode, and the engine 12 is started after the predetermined operation AMf is executed by the vehicle driver to cause the vehicle 10 to run. This control arrangement makes it possible to start the engine 12 while preventing generation of a shock, by avoiding the switching to the AWD mode and the starting of the engine 12 from being executed concurrently with each other. Further, the engine 12 is started in response to the operation of the vehicle driver which leads to starting of the engine 12. It is therefore possible to make the vehicle driver hardly feel uncomfortable when the AWD mode is selected.

In the present embodiment, the AWD mode is the driving mode in which the operation state of the engine 12 is controlled such that the engine operation ratio is higher in the AWD mode than in the 2WD mode. Thus, also in the AWD mode in which the power performance is prioritized and the engine operation ratio is high, the engine 12 can be kept in the stopped state until execution of the operation for causing the vehicle 10 to actually run. This control arrangement makes it possible to achieve both the energy efficiency and the power performance.

In the present embodiment, the predetermined operation AMf is the acceleration requesting operation for increasing the drive force Fr. Thus, the engine 12 can be maintained in the stopped state until the driver's intention to start running of the vehicle 10 or to accelerate the vehicle 10 is confirmed. It is therefore possible to make the vehicle driver hardly feel uncomfortable, and to improve the energy efficiency.

In the present embodiment, in the case in which the N(P)→D(R) operation is executed when the high-gear AWD mode is selected in the high-gear 2WD mode with the vehicle 10 being stopped, the stopped state of the engine 12 is maintained, and the engine 12 is started when the acceleration requesting operation is executed after execution of the N(P)→D(R) operation. Thus, the engine 12 is not started only by the preparation operation that is to be executed for causing the vehicle 10 to actually run, and the engine 12 can be maintained in the stopped state until the driver's intention to start running of the vehicle 10 or to accelerate the vehicle 10 is confirmed. Therefore, the energy efficiency can be improved.

In the present embodiment, in the case in which the engine 12 is in the stopped state when the 2WD mode is switched to the AWD mode, the creep torque is outputted from the electric motor MG. Therefore, it is possible to improve the energy efficiency while suppressing reduction of the acceleration responsiveness while improving.

In the present embodiment, the creep torque is outputted from the electric motor MG in the case in which the engine 12 is in the stopped state when the high-gear 2WD mode is switched to the high-gear AWD mode during stop of the vehicle 10. Thus, in the high-gear AWD mode, the rotation of the electric motor MG makes it easier to obtain rotation required by the operation of the auxiliary-transmission dog clutch 120 in the auxiliary transmission 106. That is, in the high-gear AWD mode, it is possible to prepare for the switching to the low-gear AWD mode.

In the present embodiment, the creep torque is outputted from the electric motor MG in the case in which the high-gear AWD mode is selected in the high-gear 2WD mode when each of the engine 12 and the electric motor MG is in the stopped state. Thus, it is possible to reliably prepare for the switching to the low-gear AWD mode even when the engine 12 is in the stopped state after the switching to the high-gear AWD mode.

In the present embodiment, in the high-gear 2WD mode, the engine intermittent operation is allowed whereby the energy efficiency can be easily improved. On the other hand, in the AWD mode, the switching of the engine 12 from the operated state to the stopped state is inhibited whereby the responsiveness of the drive force Fr can be easily ensured. Further, in the AWD mode, it is possible to prevent a so-called “busy feel” that could be caused if the engine 12 is switched to the operated state immediately after being switched to the stopped state.

There will be described another embodiment of this invention. The same reference signs as used in the above-described first embodiment will be used in the following embodiment, to identify the functionally corresponding elements, and descriptions thereof are not provided.

### Second Embodiment

In the above-describe first embodiment, the electric-motor control portion 92b causes the electric motor MG to output the creep torque, if the electric motor MG is in the stopped state when the high-gear 2WD mode is switched to the high-gear AWD mode with the engine 12 being kept in the stopped state. In the high-gear 2WD mode, the energy efficiency is important, and it is not necessary to prepare the switching to low-gear AWD mode. Therefore, when the high-gear AWD mode has been switched to the high-gear 2WD mode with the creep torque being outputted from the electric motor MG, it is conceivable to immediately stop output of the clip torque by placing the electric motor MG into the stopped state. However, in a case in which the acceleration requesting operation is executed immediately after execution of an operation related to running of the vehicle such as operation of the driving-state selection dial switch 81, there is a possibility that the vehicle driver has a high demand for starting running of the vehicle 10 and accelerating the vehicle 10 at high responsiveness.

In the present second embodiment, in a case in which the high-gear 2WD mode is selected in the high-gear AWD mode when the creep torque is being outputted from the electric motor MG, the electric-motor control portion 92b reduces the MG torque Tm from the creep torque toward zero after a predetermined time TMf has elapsed from completion of switching from the high-gear AWD mode to the high-gear 2WD mode by the driving-mode control portion 96. The electric-motor control portion 92b reduces the MG torque Tm by stopping the output of the creep torque, namely, by placing the electric motor MG into the stopped state. The predetermined time TMf is a predetermined threshold value that makes a determination that the demand for starting running of the vehicle 10 and accelerating the vehicle 10 at high responsiveness has become low.

When the automatic transmission 24 is in the non-driving position with the shift lever 66 being placed in the P operation position or N operation position as the shift operation position POSsh, it is considered that the vehicle driver has a low intention to drive the vehicle 10. The electric-motor control portion 92b reduces the MG torque Tm in a case in which the high-gear AWD mode is switched to the high-gear 2WD mode when the automatic transmission 24 is in the non-driving position.

Specifically, the driving-mode control portion 96 determines whether the high-gear AWD mode as one of the driving modes is established or not.

When it is determined by the driving-mode control portion 96 that the high-gear AWD mode is established, the electric-motor control portion 92b determines whether the creep torque is being outputted from the electric motor MG with the engine 12 being in the stopped state.

When it is determined by the electric-motor control portion 92b that the creep torque is being outputted from the electric motor MG, the driving-mode control portion 96 determines whether the high-gear 2WD mode is selected based on the dial-switch operation position POSdl.

When determining that the high-gear 2WD mode is selected, the driving-mode control portion 96 switches from the high-gear AWD mode to the high-gear 2WD mode. The driving-mode control portion 96 determines whether switching from the high-gear AWD mode to the high-gear 2WD mode has been completed or not.

When it is determined by the driving-mode control portion 96 that the switching from the high-gear AWD mode to the high-gear 2WD mode has been completed, the hydraulic-pressure control portion 94 determines whether the automatic transmission 24 is placed in the non-driving position or not.

When it is determined by the hydraulic-pressure control portion 94 that the automatic transmission 24 is placed in the non-driving position, the electric-motor control portion 92b determines whether the predetermined time TMf has elapsed from completion of the switching to the high-gear 2WD mode. When determining that the predetermined time TMf has elapsed, the electric-motor control portion 92b stops the output of the creep torque from the electric motor MG, namely, places the electric motor MG into the stopped state.

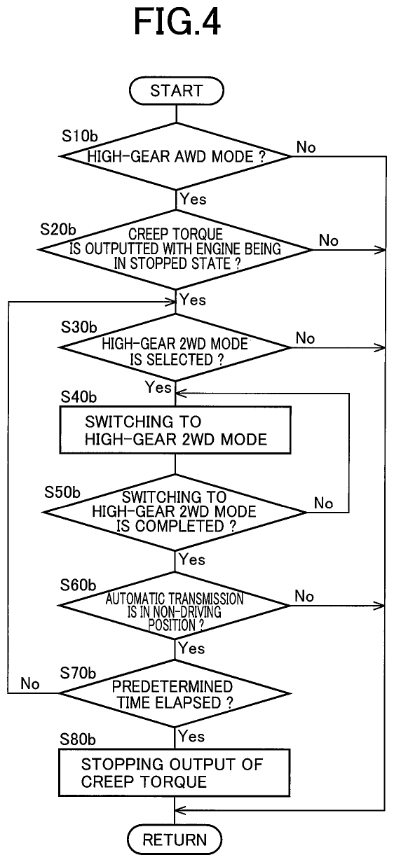

FIG. 4 is a flow chart showing a main part of a control routine executed by the electronic control apparatus 90, namely, a control routine that is executed when the AWD mode is switched to the 2WD mode during output of a creep torque, wherein the control routine is different from that shown in FIG. 3. This control routine is executed, for example, in a repeated manner.

As shown in FIG. 4, the control routine is initiated with step S10b corresponding to function of the driving-mode control portion 96, which is implemented to determine whether the high-gear AWD mode as one of the driving modes is established or not. When a negative determination is made at step S10b, one cycle of execution of the control routine is terminated. When an affirmative determination is made at step S10b, step S20b corresponding to function of the electric-motor control portion 92b is implemented to determine whether the creep torque is being outputted from the electric motor MG with the engine 12 being in the stopped state. When a negative determination is made at step S20b, one cycle of execution of the control routine is terminated. When an affirmative determination is made at step S20b, step S30b corresponding to function of the driving-mode control portion 96 is implemented to determine whether the high-gear 2WD mode is selected or not. When a negative determination is made at step S30b, one cycle of execution of the control routine is terminated. When an affirmative determination is made at step S30b, step S40b corresponding to function of the driving-mode control portion 96 is implemented to switch from the high-gear AWD mode to the high-gear 2WD mode. Step S40b is followed by step S50b corresponding to function of the driving-mode control portion 96, which is implemented to determine whether switching from the high-gear AWD mode to the high-gear 2WD mode has been completed or not. When a negative determination is made at step S50b, the control flow goes back to step S40b. When an affirmative determination is made at step S50b, step S60b corresponding to function of the hydraulic-pressure control portion 94 is implemented to determine whether the automatic transmission 24 is in the non-driving position or not. When a negative determination is made at step S60b, one cycle of execution of the control routine is terminated. When an affirmative determination is made at step S60b, step S70b corresponding to function of the electric-motor control portion 92b is implemented to determine whether the predetermined time TMf has elapsed from completion of the switching to the high-gear 2WD mode, or not. When a negative determination is made at step S70b, the control flow goes back to step S30b. When an affirmative determination is made at step S70b, step S80b corresponding to function of the electric-motor control portion 92b is implemented to place the electric motor MG into the stopped state so as to stop the output of the creep torque. It is noted that, in the present second embodiment, the control routine shown in FIG. 3 as well as the control routine shown in FIG. 4 may be executed.

As described above, In the present second embodiment, in the case in which the high-gear 2WD mode is selected in the high-gear AWD mode when the creep torque is being outputted from the electric motor MG, the MG torque Tm is reduced toward zero after the predetermined time TMf has elapsed from the completion of the switching from the high-gear AWD mode to the high-gear 2WD mode. This control arrangement makes it possible to improve the energy efficiency while suppressing reduction of the acceleration responsiveness after the switching to the high-gear 2WD mode.

In the present second embodiment, the MG torque Tm is reduced in the case in which the high-gear AWD mode is switched to the high-gear 2WD mode when the automatic transmission 24 is in the non-driving position. Thus, the energy efficiency can be appropriately improved when the preparation operation is not executed for causing the vehicle 10 to actually run.

While the preferred embodiments of this invention have been described in detail by reference to the drawings, it is to be understood that the invention may be otherwise embodied.

For example, in the above-described first embodiment, at step S70 of the control routine shown in the flow chart of FIG. 3, it may be determined whether the acceleration requesting operation as the predetermined operation AMf has been executed or not, after the N(P)→D(R) operation has been executed during stop of the vehicle 10. Further, in the control routine shown in the flow chart of FIG. 3, step S50 does not necessarily have to be implemented, and the engine intermittent operation does not necessarily have to be inhibited at step S80. Moreover, the control routine shown in the flow chart of FIG. 3 may be executed during stop of the vehicle 10.

In the above-described second embodiment, in the control routine shown in the flow chart of FIG. 4, step S60b does not necessarily have to be implemented. Further, the control routine shown in the flow chart of FIG. 4 may be executed during stop of the vehicle 10.

In the above-described embodiments, where the vehicle 10 is provided with a starter serving as a motor to be used exclusively for cranking the engine 12, it is possible to employ a method of starting the engine 12 by igniting the engine 12 after cranking the engine 12 by the starter, in a case in which the cranking cannot be made at all or satisfactorily by the electric motor MG, for example, due to an extremely low outside temperature when the vehicle 10 has been stopped with the MG rotational speed Nm being zero.

In the above-described embodiments, the automatic transmission 24 is an automatic transmission of a planetary gear type. However, the automatic transmission 24 may be any one of other type transmissions such as a known belt-type continuously variable transmission and a synchronous mesh twin shaft parallel axis-type automatic transmission including a known DCT (Dual Clutch Transmission).

In the above-described embodiments, the vehicle 10 is an AWD vehicle based on a 2WD vehicle of FR system, and is a parallel-type hybrid electric vehicle in which the drive power from the engine 12 and the electric motor MG is to be transmitted to the rear wheels 16 and optionally the front wheels 14. However, the present invention is applicable to also an AWD vehicle based on a 2WD vehicle of FR (front engine and rear drive) system, a hybrid electric vehicle including a known electrically-operated continuously-variable transmission, and a series-type hybrid electric vehicle in which the drive power is to be transmitted to the drive wheels, wherein the drive power is to be generated by an electric motor that is driven by an electric power of the battery and/or an electric power of the generator driven by a power of the engine. In the series-type hybrid electric vehicle, the automatic transmission may be either present or absent.

In the above-described embodiments, the AWD system does not necessarily have to be provided with the transfer 26 and the ADD mechanism 37. For example, in the AWD system, the switching may be made simply between the 2WD mode and the AWD mode, without the provision of the ADD mechanism 37. Further, in the AWD system, the switching may be made simply between the 2WD mode and the AWD mode, without the auxiliary transmission 106 being included in the transfer 26. In this case without the auxiliary transmission 106 being included in the transfer 26, the MG idling control is not executed in preparation for the switching between the high-gear AWD mode and the low-gear AWD mode.

In the above-described embodiments, the fluid-type transmission device in the form of the torque converter 22 is provided in the power transmission apparatus 18. However, the provision of the torque converter 22 is not essential. For example, the fluid-type transmission device may be constituted by, in place of the torque converter 22, by another fluid-type transmission device such as a fluid coupling device without a function of torque boost effect. Moreover, the fluid-type transmission device does not necessarily have to be provided but may be replaced by a starting clutch, for example.

It is to be understood that the embodiments described above are given for illustrative purpose only, and that the present invention may be embodied with various modifications and improvements which may occur to those skilled in the art.

### Nomenclature of Elements

10: vehicle (hybrid electric vehicle)
12: engine
14: front wheel (auxiliary drive wheel)
16: rear wheel (main drive wheel)
18: power transmission apparatus (vehicle power transmission apparatus)
26: transfer (drive-power distribution device)
90: electronic control apparatus (control apparatus)
92a: engine control portion
92b: electric-motor control portion
96: driving-mode control portion
106: auxiliary transmission (transmission)
120: auxiliary-transmission dog clutch (dog clutch)
MG: electric motor

What is claimed is:

1. A control apparatus for a hybrid electric vehicle that includes an engine, an electric motor, main and auxiliary drive wheels and a drive-power distribution device configured to distribute a drive power to the main and auxiliary drive wheels,
the control apparatus comprising:
an engine control portion configured to control an operation state of the engine; and
a driving-mode control portion configured to control running of the vehicle so as to realize selected at least one of driving modes which is selected by a driver of the vehicle,
wherein the driving modes include a main-drive-wheel driving mode in which the vehicle is to run with the drive power being distributed to the main drive wheels, and an all-wheel driving mode in which the vehicle is to run with the drive power being distributed to the main drive wheels and the auxiliary drive wheels, and
wherein, when the all-wheel driving mode is selected in the main-drive-wheel driving mode with the engine being in a stopped state, the engine control portion is configured to maintain the stopped state of the engine until completion of switching from the main-drive-wheel driving mode to the all-wheel driving mode by the driving-mode control portion, and to start the engine after a predetermined operation is executed by the driver of the vehicle to cause the vehicle to run.

2. The control apparatus according to claim 1,
wherein the all-wheel driving mode is a driving mode in which the operation state of the engine is controlled such that an engine operation ratio, which is a ratio of an operation time of the engine to an operation time of the vehicle, is higher in the all-wheel driving mode than in the main-drive-wheel driving mode.

3. The control apparatus according to claim 1,
wherein the predetermined operation is an acceleration requesting operation for increasing the drive power.

4. The control apparatus according to claim 1,
wherein the vehicle includes a vehicle power transmission apparatus including the drive-power distribution device and configured to transmit the drive power toward the main and auxiliary drive wheels,
wherein the vehicle power transmission apparatus is to be selectively placed in a driving position that enables transmission of the drive power and a non-driving position that disables the transmission of the drive power,
wherein the predetermined operation is an acceleration requesting operation for increasing the drive power, and
wherein, in a case in which a switching operation is executed for switching from a state for selecting the non-driving position of the vehicle power transmission apparatus to a state for selecting the driving position of the vehicle power transmission apparatus, when the all-wheel driving mode is selected in the main-drive-wheel driving mode with the vehicle being stopped, the engine control portion is configured to maintain the stopped state of the engine, and to start the engine when the acceleration requesting operation is executed after execution of the switching operation.

5. The control apparatus according to claim 1, further comprising an electric-motor control portion that is configured to cause the electric motor to output a predetermined torque causing a creep phenomenon in a case in which the engine is in the stopped state when the main-drive-wheel driving mode is switched to the all-wheel driving mode.

6. The control apparatus according to claim 5,
wherein, in a case in which the main-drive-wheel driving mode is selected in the all-wheel driving mode when the predetermined torque is being outputted from the electric motor, the electric-motor control portion is configured to reduce an output torque of the electric motor form the predetermined torque toward zero after a predetermined time has elapsed from completion of switching from the all-wheel driving mode to the main-drive-wheel driving mode by the driving-mode control portion.

7. The control apparatus according to claim 6,
wherein the vehicle includes a vehicle power transmission apparatus including the drive-power distribution device and configured to transmit the drive power toward the main and auxiliary drive wheels,
wherein the vehicle power transmission apparatus is to be selectively placed in a driving position that enables transmission of the drive power and a non-driving position that disables the transmission of the drive power, and
wherein the electric-motor control portion is configured to reduce the output torque of the electric motor, in a case in which the all-wheel driving mode is switched to the main-drive-wheel driving mode when the vehicle power transmission apparatus is in the non-driving position.

8. The control apparatus according to claim 1,
wherein the drive-power distribution device includes a transmission in which a selected one of a low gear position and a high gear position is to be established by operation of a dog clutch,
wherein the all-wheel driving mode is categorized into a low-gear all-wheel driving mode in which the low gear position is established in the transmission and a high-gear all-wheel driving mode in which the high gear position is established in the transmission,
wherein the main-drive-wheel driving mode is a high-gear main-drive-wheel driving mode in which the high gear position is established in the transmission, and
wherein the control apparatus further comprises an electric-motor control portion that is configured to cause the electric motor to output a predetermined torque causing a creep phenomenon, in a case in which the engine is in the stopped state when the high-gear main-drive-wheel driving mode is switched to the high-gear all-wheel driving mode during stop of the vehicle.

9. The control apparatus according to claim 8,
wherein the electric-motor control portion is configured to cause the electric motor to output the predetermined torque, in a case in which the high-gear all-wheel driving mode is selected in the high-gear main-drive-wheel driving mode when each of the engine and the electric motor is in the stopped state.

10. The control apparatus according to claim 1,
wherein the engine control portion is configured, in the main-drive-wheel driving mode, to allow an engine intermittent operation in which the engine is placed alternately in an operated state and the stopped state, and is configured, in the all-wheel driving mode, to inhibit switching of the engine from the operated state to the stopped state.
